(19) United States
(12) Patent Application Publication
(10) Pub. No.: US 2007/0087262 A1
(43) Pub. Date: Apr. 19, 2007

(54) Membrane-electrode assembly for fuel cell, method for manufacturing the same, and fuel cell system using the membrane-electrode assembly

(76) Inventors: In Hyuk Son, Yongin (KR); Han Kyu Lee, Yongin (KR); Chan Kwak, Yongin (KR)

Correspondence Address: CHRISTIE, PARKER & HALE, LLP, PO BOX 7068, PASADENA, CA, 91109-7068, US

(21) Appl. No.: 11/581,138

(22) Filed: Oct. 13, 2006

(30) Foreign Application Priority Data
Oct. 19, 2005 (KR) 2005-98650

(51) Int. Cl. H01M 4/94; H01M 4/88

(52) U.S. Cl. 429/44; 502/101

(57) ABSTRACT

A membrane-electrode assembly in which an opening, a catalyst layer and a diffusing layer are placed within a cathode active region; a method for manufacturing the same; and a fuel cell system using the membrane-electrode assembly. The membrane-electrode assembly comprises: a cathode with a catalyst layer, an opening in the catalyst layer, and a diffusing layer; an anode with a catalyst layer and a diffusing layer; and an electrolyte membrane between the cathode and the anode. A hydrogen ion generated by oxidizing a liquid fuel is transferred to the cathode via the electrolyte membrane, and returns to the anode without reaction in the cathode, so that the hydrogen ion is reduced in the anode by receiving electrons from the anode, thereby generating hydrogen gas on the anode channel. The hydrogen gas is used as a high efficiency fuel, thereby enhancing the output performance of the fuel cell.

### CROSS-REFERENCE TO RELATED APPLICATIONS

This application claims priority to and the benefit of Korean Patent Application No. 2005-98650, filed on Oct. 19, 2005, in the Korean Intellectual Property Office, the entire content of which is incorporated herein by reference.

### BACKGROUND

1. Field of the Invention

The invention relates to a direct methanol fuel cell system, and more particularly, to a membrane-electrode assembly in which an opening, a catalyst layer and a diffusing layer are placed within a cathode active region; a method for manufacturing the same; and a fuel cell system using the membrane-electrode assembly.

2. Discussion of Related Art

A fuel cell is a power generation system that directly changes chemical reaction energy due to a reaction between hydrogen and oxygen into electrical energy, in which hydrogen is contained in a fuel such as methanol, ethanol, natural gas or the like.

In a fuel cell system, a stack substantially generating electricity has a structure in which a plurality of unit cells, including a membrane-electrode assembly (MEA) and a separator, are stacked. Here, the MEA has a structure such that an anode (so-called a “fuel electrode” or an “oxidation electrode”) and a cathode (so-called an “(air electrode” or a “reduction electrode”) are fixed respectively on both surfaces of a polymer electrolyte membrane. The separator has a passage to supply the fuel needed for the reaction at the anode, and functions as a conductor to connect the anode with the cathode of unit cells in series.

Below, the conventional MEA will be described in more detail with reference to FIG. 1. FIG. 1 is an exploded sectional view of a membrane-electrode assembly of a conventional fuel cell.

Referring to FIG. 1, the membrane-electrode assembly includes an anode 20 and a cathode 30 located at opposite sides of an electrolyte membrane 10. The anode 20 includes a catalyst layer 22, a diffusing layer 24, and a carbon base material 26, and the cathode 30 includes a catalyst layer 32, a diffusing layer 34, and a carbon base material 36. The diffusing layer 24 and the carbon base material 26 can be mentioned as a diffusing layer, and the diffusing layer 34 and the carbon base material 36 can be mentioned as another diffusing layer.

The electrolyte membrane 10 is used for transferring protons produced in the anode 20 to the cathode 30, insulating the cathode 30 from electrons produced in the anode 20, preventing un-reacted fuel from being transferred from the anode 20 to the cathode 30, and preventing un-reacted oxidant from being transferred from the cathode 30 to the anode 20.

The catalyst layer 22 functions as an electrode to promote the oxidation reaction of a fuel, and the catalyst layer 32 functions as an electrode to promote reduction reaction of protons produced the fuel. The diffusing layers 24 and 34 support the anode and the cathode and diffuses reactants toward the catalyst layers 22 and 32, thereby allowing the reactants to be easily transferred to the catalyst layers 22 and 32. The carbon base materials 26 and 36 are made of carbon cloth, carbon paper, etc. The carbon base materials 26 and 36 are used as a fuel diffuser to uniformly diffuse fuel, water, air, etc.; and a protector to the catalyst layers and the diffusing layers from being worn out by fluid.

Meanwhile, in the prior art a fuel cell stack has a structure where a plurality of unit cells including a membrane-electrode assembly (MEA) and a separator are stacked, so that a number of unit cells should be stacked to improve the output performance thereof, thereby increasing the volume of the stack.

Accordingly, the stack is required to have a high output performance and a small volume, i.e., have a high output density.

### SUMMARY OF THE INVENTION

Accordingly, one embodiment of the invention provides a membrane-electrode assembly, in which an opening is provided in a cathode catalyst layer, thereby improving an output density.

Another embodiment of the invention provides a method of manufacturing a membrane-electrode assembly, in which an opening is formed in an active region of a cathode catalyst layer, so that the output performance of a fuel cell is improved.

Still another embodiment of the invention provides a fuel cell system with a membrane-electrode assembly, in which hydrogen gas is generated on an anode channel through which a liquid fuel is supplied, and the generated hydrogen gas is recycled as a high efficiency fuel, thereby enhancing output density thereof.

According to a one embodiment of the invention, a membrane-electrode assembly comprises: a cathode provided with a catalyst layer, an opening formed in the catalyst layer, and a diffusing layer; an anode provided with a catalyst layer and a diffusing layer; and an electrolyte membrane placed between the cathode and the anode.

According to another embodiment of the invention, a method of manufacturing a membrane-electrode assembly, comprises: (a) manufacturing a cathode catalyst layer unit by forming a cathode catalyst layer having an opening on a first film; (b) manufacturing an anode catalyst layer unit by forming an anode catalyst layer on a second film; (c) manufacturing a diffusing layer unit by forming a diffusing layer on a second film; (d) manufacturing an anode electrode unit and a cathode electrode unit by adhering between the anode catalyst layer unit to the diffusing layer unit and adhering the cathode catalyst layer unit to another diffusing layer unit to make the catalyst layers of the anode and cathode catalyst layer units contact the diffusing layers of the diffusing layer unit; and (e) adhering the anode electrode unit and the cathode electrode unit to opposite sides of the electrolyte membrane.

According to a further embodiment of the invention, a method of manufacturing a membrane-electrode assembly, comprises: (a) forming a cathode catalyst layer having an opening on one surface of an electrolyte membrane; (b) forming an anode catalyst layer on the other surface of the electrolyte membrane; (c) manufacturing a diffusing layer unit by forming a diffusing layer on a film; and (d) adhering the diffusing layer units to opposite sides of the electrolyte membrane having the catalyst layer to make the anode catalyst layer and the cathode catalyst layer contact the diffusing layer of the diffusing layer unit.

According to one embodiment of the invention, a method of manufacturing a membrane-electrode assembly, comprises: (a) forming a rugged pattern on a first surface of an electrolyte membrane; (b) applying an anode catalyst layer to the first surface of the electrolyte membrane; (c) manufacturing a catalyst layer unit by applying a cathode catalyst layer having an opening onto a film and drying the cathode catalyst layer; (d) manufacturing a diffusing layer unit by forming a diffusing layer on another film and sintering the diffusing layer; (e) manufacturing an electrode unit by adhering the catalyst layer unit and the diffusing layer unit to one another such that the cathode catalyst layer of the catalyst layer unit contacts the diffusing layer of the diffusing layer unit; (f) removing the film from the catalyst layer unit; (g) adhering the diffusing layer unit to the first surface of the electrolyte membrane and the electrode unit to a second surface of the electrolyte membrane; and (h) removing the film from the diffusing layer.

According to another embodiment of the invention, a fuel cell system includes: an electricity generator including a membrane-electrode assembly, and separators provided on opposite sides of the membrane-electrode assembly; a fuel feeder to supply fuel to the electricity generator; and an oxidant feeder to supply an oxidant to the electricity generator, wherein the membrane-electrode assembly comprises a cathode provided with a catalyst layer, an opening formed in the catalyst layer, and a diffusing layer; an anode provided with a catalyst layer and a diffusing layer; and an electrolyte membrane placed between the cathode and the anode.

### BRIEF DESCRIPTION OF THE DRAWINGS

The accompanying drawings, together with the specification, illustrate exemplary embodiments of the invention, and, together with the description, serve to explain the principles of the invention.

FIG. 1 is an exploded sectional view of a membrane-electrode assembly of a conventional fuel cell according to the prior art;

FIG. 2 is an exploded sectional view of a membrane-electrode assembly according to one embodiment of the invention;

FIG. 3 is a graph showing that output density is changed according to areas of an opening provided in a cathode electrode of the membrane-electrode assembly of FIG. 2;

FIG. 4 is a flowchart of manufacturing the membrane-electrode assembly according to one embodiment of the invention;

FIG. 5 is an exploded sectional view of a membrane-electrode assembly for a fuel cell according to one embodiment of the invention;

FIGS. 6A and 6B are sectional views showing a process of forming a rugged structure on one surface of an electrolyte membrane of the membrane-electrode assembly according to one embodiment of the invention;

FIG. 7 is a schematic view of a direct methanol fuel cell system employing a membrane-electrode assembly according to one embodiment of the invention;

FIG. 8 is a partially enlarged sectional view of an electricity generating part of the direct methanol fuel cell system according to one embodiment of the invention; and

FIG. 9 is a graph showing the output performances of the fuel cell systems according to inventive and comparative examples according to one embodiment of the invention.

### DETAILED DESCRIPTION

In the following detailed description, certain exemplary embodiments of the invention are shown and described by way of illustration. As those skilled in the art would recognize, the described exemplary embodiments may be modified in various ways, all without departing from the spirit or scope of the invention. Accordingly, the drawings and description are to be regarded as illustrative in nature, rather than restrictive.

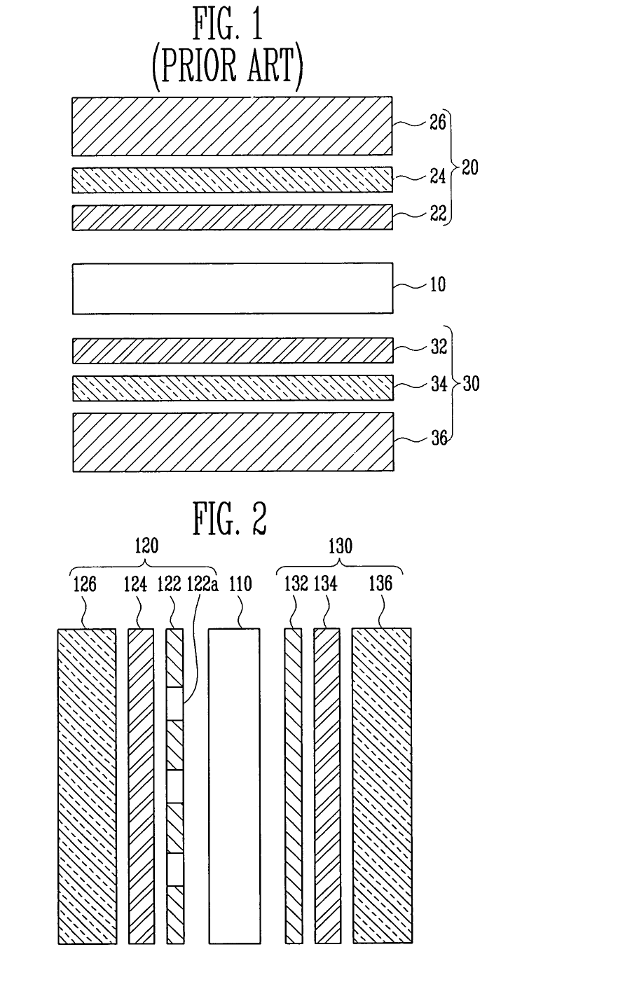

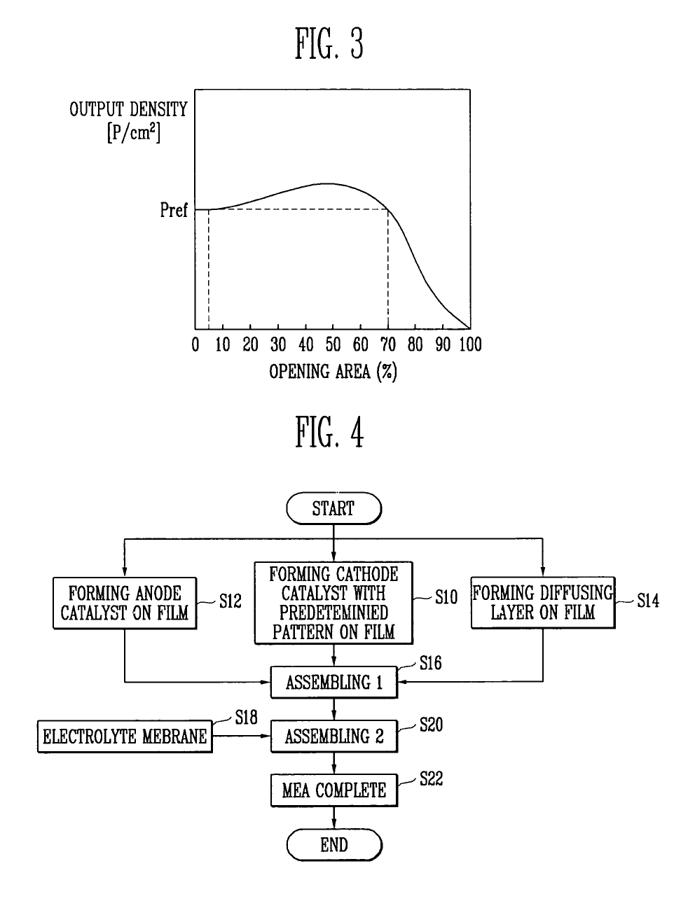

FIG. 2 is an exploded sectional view of a membrane-electrode assembly according to one embodiment of the invention.

Referring to FIG. 2, in one embodiment, a membrane-electrode assembly includes an electrolyte membrane 110, and a cathode electrode 120 and an anode electrode 130 placed on opposite sides of the electrolyte membrane 110. The cathode electrode 120 includes a catalyst layer 122 formed with an opening 122a, and diffusing layers 124 and 126. The anode electrode 130 includes a catalyst layer 132 and diffusing layers 134, 136.

The foregoing electrolyte membrane 110 and the anode electrode 130 can be provided using well-known electrolyte membranes and well-known anode electrodes. However, the cathode electrode 120 according to the invention is characterized in that the opening 122a directly exposes a part of the electrolyte membrane 110 to the diffusing layer 124.

In one embodiment, the opening 122a is formed as a predetermined pattern. The opening 122a can have a polygonal shape such as a circle shape, a rectangular shape, a triangular shape, etc. Further, in one embodiment, the opening 122a may have an elongated line shape. Thus, the opening 122a can have various shapes according to the shape of the cathode catalyst 122. For example, in one embodiment, the opening 122a is a mesh shape or a divided pattern of a plurality of catalyst layers. In one embodiment, the area of the opening 122a is 5% to 70% of the area of the cathode catalyst layer 122. As shown in FIG. 3, when the area of the opening 122a is less than 5% of the area of the catalyst layer 122, hydrogen is slightly generated, so that the output density of the stack insignificantly improved. Additionally, when the area of the opening 122a is higher than 70%, the cathode catalyst layer is insufficient for a reduction reaction of a reactant, thereby obtaining an output density lower than a reference output density P_{ref} of the stack.

In one embodiment, the electrolyte membrane 110 includes one or more hydrogen ion conductive polymers selected from a group consisting of perfluoride polymer, benzimidazole polymer, polyimide polymer, polyetherimide polymer, polyphenylenesulfide polymer, polysulfone polymer, polyethersulfone polymer, polyetherketone polymer, polyether-etherketone polymer, polyphenylquinoxaline polymer, and combinations thereof. In another embodiment, the electrolyte membrane 111 includes one or more hydrogen ion conductive polymers selected from a group consisting of poly(perfluorosulfone acid), poly(perfluorocarboxyl acid), copolymers of fluorovinylether and tetrafluoroethylene including sulfone acid, defluoride polyetherketon sulfide, aryl ketone, poly(2,2′-(m-phenylene)-5,5′-bibenzimidazole), poly(2,5-benzimidazole), and combinations thereof.

In an embodiment, each catalyst layer 122, 132 of the cathode and anode electrodes 120 and 130 includes one or more metal catalysts selected from a group consisting of one or more transition metals selected from a group consisting of platinum, ruthenium, osmium, platinum-ruthenium alloy, platinum-osmium alloy, platinum-palladium alloy, platinum-M alloy (where, M includes Ga, Ti, V, Cr, Mn, Fe, Co, Ni, Cu and Zn), and combinations thereof.

Further, in one embodiment, the catalyst layer 122, 132 may include one or more metal catalysts selected from a group consisting of platinum deposited on supports, ruthenium, osmium, platinum-ruthenium alloy, platinum-osmium alloy, platinum-palladium alloy, platinum-M alloy (where, M includes one or more transition metals selected from a group consisting of Ga, Ti, V, Cr, Mn, Fe, Co, Ni, Cu and Zn), and combinations thereof. Here, the supports can include any material as long as it is conductive. In another embodiment, the supports are carbon.

Also, in an embodiment, each catalyst layer 122, 132 includes from 10 wt % to 80 wt % metal catalyst with respect to total wt % thereof, and more preferably, the catalyst layer 122, 132 includes 20 wt % to 60 wt % metal catalyst with respect to total wt % thereof. When the content of the metal catalyst is less than 10 wt %, the catalyst layer should become thicker, causing the reactants and products to not be smoothly supplied and discharged, respectively. On the other hand, when the content of the metal catalyst is higher than 80 wt %, the particle size of the catalyst is so big that the surface area for the reaction decreases, thereby deteriorating the efficiency, wasting the catalyst, and increasing production costs.

In one embodiment, a first diffusing layer 124, 134 of the cathode and anode electrodes 120 and 130 supports the electrodes 120 and 130 and diffuses the reactants toward the catalyst layer 122, 132, thereby allowing the reactants to easily approach the catalyst layer 122, 132. The first diffusing layer 124, 134 can be implemented using a microporous layer applied to and formed in a second diffusing layer 126, 136 (to be described later).

In one embodiment, the microporous layer includes one or more carbon materials selected from a group consisting of graphite, carbon nano-tube (CNT), fullerene (C60), activated carbon, Vulcan, ketchen black, carbon black, carbon nano-horn, and combinations thereof. In a further embodiment, the microporous layer can include one or more binders selected from a group consisting of poly(perfluorosulfone acid), poly(tetrafluoroethylene), fluorinated ethylene-propylene, and combinations thereof.

Each second diffusing layer 126, 136 of the cathode and anode electrodes 120 and 130 is used for diffusing the fuel, water and air uniformly; collecting generated electricity; and protecting the catalyst layer 122, 132 and the first diffusing layer 124, 134 from loss by the fluid. In an embodiment, the second diffusing layer 126, 136 can be implemented by carbon materials such as carbon cloth, carbon paper or the like.

In one embodiment, the anode electrode 130 of the electrodes may include a hydrous layer instead of the second diffusing layer 136, and the hydrous layer is placed on an opposite surface of the first diffusing layer 134, which is in contact with the catalyst layer 132. The hydrous layer assists the electrolyte membrane in hydration. In an embodiment, the hydrous layer can include SiO2, TiO2, phosphotungstic acid and phosphomolybdenum, but is not limited thereto. The hydrous layer may include various materials as long as it is hydrous.

In one embodiment, the hydrous layer has a thickness of 0.01 μm through 1 μm. Here, the hydrous layer is non-conductive, so that a non-conductive layer is formed when the first diffusing layer 134 is entirely covered with the hydrous material, and thus the generated electricity is not collected. Therefore, the hydrous layer in one embodiment is formed as a discontinuous layer with small “islands.”

Below, a method of manufacturing the membrane-electrode assembly according to one embodiment of the invention will be described with reference to FIG. 4.

Manufacturing a Catalyst Layer Unit

First, the cathode catalyst layer is formed as a predetermined pattern on a film and dried, thereby manufacturing a cathode catalyst layer unit (S10). Further, a anode catalyst layer is formed on the film and dried, thereby manufacturing an anode catalyst layer unit (S12). In one embodiment, the film includes a Teflon film, a polyethylene terephthalate (PET) film, a captone film, a Tedlar film, an aluminum foil, a mylar film, etc., but it is not limited thereto. Alternatively, any film can be used as long as it can transfer the catalyst layer formed thereon.

Any method can be used to form the catalyst layer as long as it can form the catalyst layer with a uniform thickness on the film. In one embodiment of the method of forming the catalyst layer, a catalyst slurry is coated on the film by a tape casting method, a spray method, or a screen printing method, but the method is not limited thereto.

In an embodiment, the method of forming the cathode catalyst layer having a predetermined pattern in order to form the opening is also implemented by the aforementioned method. In addition, to form the opening in the catalyst layer, the foregoing process can be performed in consideration of a predetermined pattern or using a mask or the like. In one embodiment, the method of forming the cathode catalyst layer with a predetermined pattern can include a spray coating method to form the catalyst layer locally, and a transfer method to transfer the catalyst layer, having a predetermined pattern, from the film. Thereafter, the following process of patterning the cathode catalyst layer can be omitted.

In one embodiment, the opening can have various shapes according to the shape of the cathode catalyst, for example, a mesh-like shape or a divided pattern of a plurality of catalyst layers. In an embodiment, the area of the opening is between 5% and 70% of the area of the cathode catalyst layer.

In one embodiment, the catalyst slurry may be obtained by dispersing a support catalyst into a liquid or by dispersing catalyst particles into a matrix and then dispersing the matrix into the liquid. Further, the composition and elements of the catalyst may be changed according to whether the catalyst layer unit is used in an electrode unit for the anode electrode or the cathode electrode.

In one embodiment, the liquid is employed as a dispersion medium, and may be water, ethanol, methanol, isopropylalcohol, n-propylalcohol, butylalchohol, etc., but is not limited thereto. In another embodiment, water, ethanol, methanol and isopropylalcohol may be used.

In an embodiment, the catalyst slurry can include a conductive material, e.g., NAFION™.

In one embodiment, when the catalyst slurry is made, the support catalyst, the dispersion medium, and the conductive material are preferably mixed in a ratio of 1:3:0.15, but not limited thereto. In another embodiment, the catalyst slurry is made by stirring the mixture in a sonic bath for one to three hours.

In one embodiment, the catalyst layer is dried for one to four hours at a temperature in the range of 60° C. to 120° C., thereby removing the dispersion medium therefrom. When the catalyst layer is dried at a very low temperature below the foregoing temperature range, the dispersion medium is not sufficiently removed, so that the catalyst layer is not completely dried. On the other hand, when the catalyst layer is dried in a very high temperature above the foregoing temperature range, the catalyst is likely to be damaged. Further, when the catalyst layer is dried for a very short time below the foregoing time range, the dispersion medium is insufficiently removed, so that the catalyst layer is not completely dried. On the other hand, when the catalyst layer is dried for a very long time beyond the foregoing time range, it is uneconomic.

In one embodiment, the catalyst layer has a mass per unit area in the range of 2 to 8 mg/cm². When the mass per unit area of the catalyst layer unit is too small and below the foregoing range, the catalyst layer becomes mechanically weaker. On the other hand, when the mass per unit area of the catalyst layer unit is too large and above the foregoing range, it is resistant to diffusion of the reactant, thereby deteriorating material transfer.

In one embodiment, the cathode catalyst layer unit fabricated as described above further undergoes a patterning process. In the patterning process, an opening is formed on the cathode catalyst layer unit. In an embodiment, the opening can have a polygonal shape such as a circle shape, a rectangular shape, a triangular shape, etc. In another embodiment, the opening may have an elongated line shape or various shapes.

In one embodiment, the area of the opening is in the range of 5% to 70% and less of the area of the cathode catalyst layer in consideration of the amount of catalyst contained in the patterned cathode catalyst layer unit. When the area of the opening is less than the foregoing range, hydrogen is slightly generated, so that the output density of the membrane-electrode assembly is insignificantly improved. On the other hand, when the area of the opening is greater than the foregoing range, a reduction reaction of hydrogen ions is not smoothly performed because of the small amount of the cathode catalyst layer, thereby decreasing the output density.

A patterning method can be implemented by various well-known methods. In an embodiment, the catalyst layer unit is seated onto a cutting plotter; a desired opening pattern is designed by a CAD program; and the opening is formed on the cathode catalyst layer along the opening pattern designed by the cutting plotter. However, the invention is not limited to this example, and may be implemented by various well-known methods.

Manufacturing a Diffusing Layer Unit

In one embodiment, similar to the catalyst layer unit, the diffusing layer is formed on the film and then sintered, thereby forming a diffusing layer unit (S14). Like the catalyst layer unit, in an embodiment the film includes a TEFLON™ film, a polyethylene terephthalate (PET) film, a captone film, a TEDLAR™ film, an aluminum foil, a mylar film, etc., but is not limited thereto. Alternatively, any film can be used as long as it can transfer the diffusing layer formed thereon.

Any method can be used to form the diffusing layer as long as it can form the diffusing layer with a uniform thickness on the film. In an embodiment, as an example of the method of forming the diffusing layer, a carbon slurry is coated on the film by a tape casting method, a spray method, or a screen printing method, but the method is not limited thereto.

In one embodiment, the carbon slurry can be obtained by mixing carbon powder, a binder and a dispersion medium, and the carbon powder includes a carbonaceous material such as carbon black, acetylene black, carbon nano tubes, carbon nano wire, carbon nano horns, carbon nano fibers, etc.

In one embodiment, the binder includes polytetrafluoroethylene (PTFE), polyvinylidenefluoride (PVdF), fluorinated ethylene propylene (FEP), etc., but is not limited thereto.

In an embodiment, the dispersion medium includes water, ethanol, methanol, isopropylalcohol, n-propylalcohol, butylalchohol, etc., but not limited thereto. In another embodiment, water, ethanol, methanol and isopropylalcohol may be used.

In one embodiment, the carbon powder, the binder and the dispersion medium are mixed in a ratio of 0.7:0.3:10, but the ratio is not limited thereto. In another embodiment, the carbon slurry is made by stirring the mixture in a sonic bath for a half-hour to two hours.

In one embodiment, the diffusing layer is sintered for a half-hour to two hours at a temperature in the range of 150° C. to 350° C. As the diffusing layer is sintered, not only is the dispersion medium removed, but also the binder is properly distributed to thereby obtain a proper water-repellency and prevent the loss of carbon elements. When the diffusing layer is sintered at a very low temperature below the foregoing temperature range, the binder is insufficiently distributed and not normally operated, thereby deteriorating the water-repellency. On the other hand, when the diffusing layer is sintered at a very high temperature above the foregoing temperature range, the diffusing layer unit may be deformed by overheating. Further, when the binder is sintered for a very short time less than the foregoing time range, the binder is insufficiently distributed and not normally operated, thereby deteriorating the water-repellency. On the other hand, when the binder is sintered for a very long time greater than the foregoing time range, it is not only uneconomic but also causes problems in electric conductivity.

In an embodiment, the sintering temperature is adjusted according to the type of binder. In another embodiment, the sintering temperature is determined around a melting point of the binder.

In one embodiment, the diffusing layer unit has a mass per unit area in the range of 0.1 to 4 mg/cm². When the mass per unit area of the diffusing layer unit is less than the foregoing range, the diffusing layer cannot diffuse the fuel smoothly and becomes mechanically weaker. On the other hand, when the mass per unit area of the diffusing layer unit is greater than the foregoing range, it is resistant to diffusion of the reactant, thereby deteriorating material transfer.

Thus, the diffusing layer unit is completed by the above-mentioned process.

In one embodiment, the method of manufacturing the diffusing layer unit used for the anode electrode further includes forming the hydrous layer between the film and the diffusing layer where the hydrous layer is placed on an opposite side of an anode diffusing layer, and not in contact with the anode catalyst layer. In an embodiment, the hydrous layer can be previously formed before forming the diffusing layer on the film, and then the diffusing layer can be formed on the hydrous layer. In an embodiment, the method of forming the hydrous layer can be achieved by various well-known methods such as a spray coating method to form the hydrous layer locally, and a transfer method to transfer the hydrous layer having a predetermined pattern from the film.

In an embodiment, the hydrous layer includes SiO₂, TiO₂, phosphotungstic acid and phosphomolybdenum, but it is not limited thereto. The hydrous layer may include various materials as long as it is hydrous. In one embodiment, the hydrous layer has a thickness in the range of 0.01 μm to 1 μm. Here, the hydrous layer is non-conductive, so that a non-conductive layer is formed when the first diffusing layer is entirely covered with the hydrous material, and thus the generated electricity is not collected. Therefore, the hydrous layer in one embodiment is formed as a discontinuous layer as small “islands.”

Catalyst-diffusing Adhesion

In an embodiment, the catalyst layer unit and the diffusing layer unit are adhered to each other, thereby manufacturing an electrode unit (S16), which can be used as the anode or the cathode.

A method of adhering the catalyst layer unit and the diffusing layer unit can be achieved by well-known methods in the art. In one embodiment, a hot pressing method can be used for adhering the catalyst layer unit and the diffusing layer unit.

In an embodiment, the hot pressing method may be performed under 0.1 to 1.0 ton/cm² at a temperature of 30 to 200° C. for one to twenty minutes. In another embodiment, the hot pressing method is performed at a temperature of 40 to 90° C. When the hot pressing method is performed at a very low temperature below the foregoing temperature range, the catalyst layer unit and the diffusing layer unit are incompletely adhered so that they are likely to separate from each other. On the other hand, when the hot pressing method is performed at a very high temperature above the foregoing temperature range, the catalyst may be deteriorated.

Thus, the electrode unit is manufactured by the foregoing process. According to whether the cathode catalyst layer unit or the anode catalyst layer unit is used while manufacturing the electrode unit, a cathode electrode unit or an anode electrode unit is manufactured, respectively.

The film attached to the catalyst layer unit can be removed at any time before the catalyst layer unit is dried and then adhered to the electrolyte membrane. In an embodiment, the film attached to the catalyst layer is removed in either the anode or cathode electrode unit after manufacturing the electrode unit; otherwise the process is complicated and its efficiency is deteriorated.

Membrane-electrode Adhesion

The electrolyte membrane is prepared (S18). Then, the anode electrode unit and the cathode electrode unit are adhered to the opposite sides of the electrolyte membrane (S20), thereby completing the membrane-electrode assembly (S22).

In an embodiment, the cathode electrode unit is attached to one side of the electrolyte membrane, and the anode electrode unit is attached to the other side of the electrolyte membrane. In another embodiment, the hot pressing method is used for attaching the cathode and anode electrode units to the electrolyte membrane, but it is not limited thereto.

In one embodiment, the hot pressing method may be performed under 0.1 to 1.0 ton/cm² at a temperature of 50 to 200° C. for one to twenty minutes. More preferably, the hot pressing method is performed at a temperature of 100 to 150° C. When the hot pressing method is performed at a very low temperature below the foregoing temperature range, the adhesion is not enough so that the interface resistance between the electrode and the electrolyte membrane increases. At the extreme, the catalyst layer unit and the diffusing layer unit may be separated from each other. On the other hand, when the hot pressing method is performed at a very high temperature above the foregoing temperature range, the electrolyte membrane may be deteriorated by dehydration thereof.

The film attached to the diffusing layer unit can be removed at any time after sintering the diffusing layer unit. In an embodiment, the film attached to the diffusing layer is removed after adhering the electrode units to the opposite sides of the electrolyte membrane; otherwise the process is complicated and its efficiency is deteriorated.

Thus, the membrane-electrode assembly is manufactured.

The membrane-electrode assembly according to the invention generates hydrogen gas, at a high reaction speed on the anode channel for supplying the liquid fuel, thereby allowing the stack to have high output density.

In one embodiment, in addition to a lamination method of coating the catalyst layer on the diffusing layer and laminating it with the electrolyte membrane, a method of forming the catalyst layer on the electrolyte membrane can be achieved by a deposition method such as a sputtering method, an ion ablation method, etc.; and a method of directly coating a solvent on the electrolyte membrane by a general coating method such as a spray method, a screen printing method, a slot die method, a doctor blade method, a gravier coating method, etc., in which the solvent has a dispersed mixture of catalyst and ion-conductive polymer. In an embodiment, two or more methods among the foregoing methods can be used together to form the catalyst layer on the electrolyte membrane.

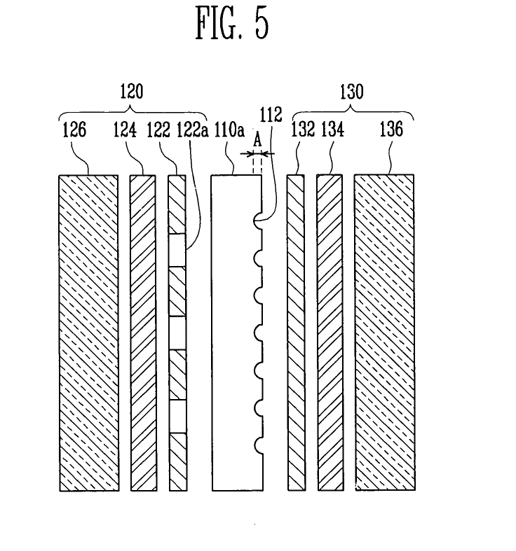

FIG. 5 is an exploded sectional view of a membrane-electrode assembly for a fuel cell according to an embodiment of the invention.

Referring to FIG. 5, the membrane-electrode assembly includes an electrolyte membrane 110a, and a cathode electrode 120 and an anode electrode 130 placed on opposite sides of the electrolyte membrane 110a. The cathode electrode 120 includes a catalyst layer 122 formed with an opening 122a, and diffusing layers 124 and 126. The anode electrode 130 includes a catalyst layer 132 and diffusing layers 134, 136.

The foregoing anode electrode 130 can be implemented by a well-known anode electrode. In one embodiment, the surface of the electrolyte membrane 110a facing the anode electrode 130 according to the invention is characterized in that it has a rugged structure with at least one groove having a predetermined depth A, and the cathode electrode 120 is formed with the opening 122a directly exposing a portion of the electrolyte 110a to the diffusing layer 124. The opening 122a according to the one embodiment is similar to that of the embodiments above, so repetitive descriptions thereof will be avoided.

The rugged structure (or pattern) provided in the electrolyte membrane 110a facing the anode electrode increases the area of interface contact between the electrolyte membrane 110a and the anode catalyst layer 132, thereby increasing the amount of catalyst to be in contact with the electrolyte membrane 110a. As the amount of catalyst to be in contact with the electrolyte membrane 110a increases, the performance regarding utilizing the catalyst and generating/transferring hydrogen ions is improved.

With this configuration, the generation of the hydrogen ion in the anode catalyst layer 132 is enhanced, so that the hydrogen ion generated in the anode electrode 130 is more smoothly transferred to the cathode electrode 120 via the electrolyte membrane 110a, and then returns to the anode electrode 130 without being reduced in the opening 122a, thereby being changed into the hydrogen gas. Therefore, the output density of the membrane-electrode assembly according to one embodiment is further enhanced as compared with that of the embodiments above.

Manufacturing the Electrolyte Membrane

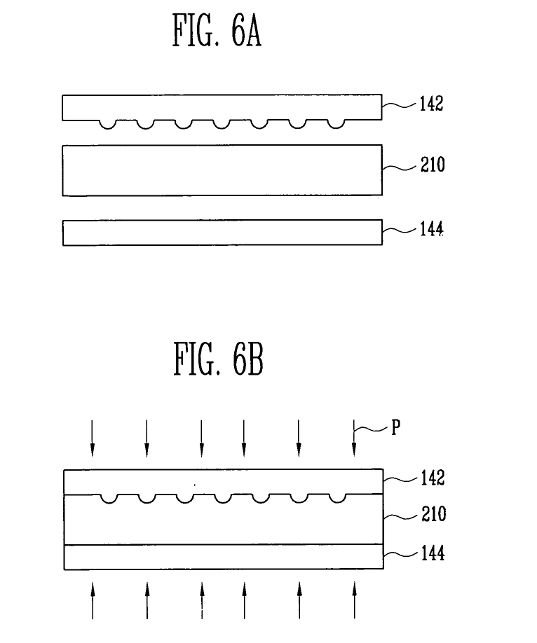

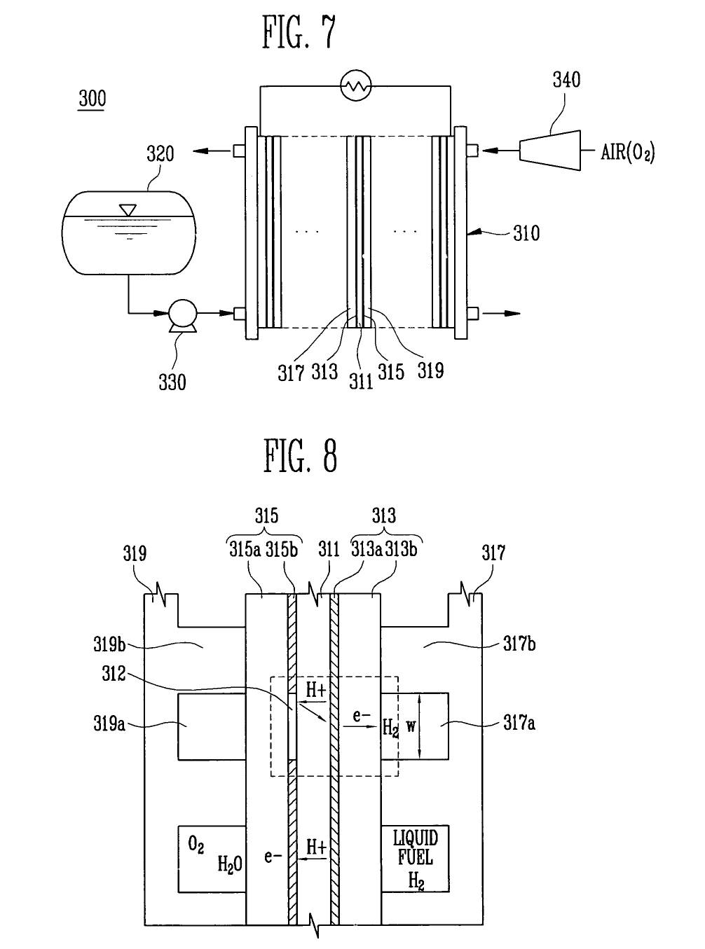

Below, a partial process of manufacturing the membrane-electrode assembly according to one embodiment will be described with reference to FIGS. 6A and 6B. FIGS. 6A and 6B are sectional views showing a process of forming a rugged structure on one surface of an electrolyte membrane of the membrane-electrode assembly according to one embodiment of the invention.

As shown in FIGS. 6A and 6B, the method of forming the rugged structure on one side of the electrolyte membrane can be implemented by placing the electrolyte membrane 210 between a pattern member 142 having a rugged structure and a plate member 144; pressing the pattern member 142 and the plate member 144 from the outside with heat and pressure (P); and separating the pattern member 142 and the plate member 144 from the electrolyte membrane 210.

In the rugged structure as shown in FIG. 5, according to one embodiment, the groove 112 has a depth of 1 to 50 microns so as to make a ratio of a real surface to a geometrical surface of the electrolyte membrane 110a range from 1.3 to 200 mm². When the ratio is less than the range, the interface area is not largely increased. On the other hand, when the ratio is above the range, it is difficult to realize it from a technical view point.

According to an embodiment, a method of forming the rugged structure on one surface of the electrolyte membrane can be achieved by placing the electrolyte membrane between opposite sides of a stainless steel mesh and applying heat and pressure thereto.

Other processes, i.e., a process of manufacturing the catalyst layer unit; a process of manufacturing the catalyst layer unit; a process of adhering the catalyst and diffusing layers; and a process of adhering the membrane and electrode are substantially equal to those of the embodiments above. Therefore, repetitive descriptions will be avoided as necessary.

In a method of manufacturing the membrane-electrode assembly according to one embodiment, a method of forming the catalyst layer on the electrolyte membrane having the rugged structure can be achieved by a deposition method such as a sputtering method, an ion ablation method, etc.; a method of directly coating a solvent on the electrolyte membrane by a general coating method such as a spray method, a screen printing method, a slot die method, a doctor blade method, a gravier coating method, etc., in which the solvent has a dispersed mixture of catalyst and ion-conductive polymer; and a lamination method of coating the catalyst layer on the diffusing layer and laminating it with the electrolyte membrane. In an embodiment, two or more methods among the foregoing methods can be used together to form the catalyst layer on the electrolyte membrane.

FIG. 7 is a schematic view of a direct methanol fuel cell system employing a membrane-electrode assembly according to an embodiment of the invention.

Referring to FIG. 7, a fuel cell system 300 includes an electricity generator 310; a fuel feeder to supply liquid fuel stored in the fuel tank 320 to an anode electrode of the electricity generator 310 by a fuel pump 330; and an oxidant feeder 340 to supply an oxidant such as oxygen to a cathode electrode of the electricity generator 310.

The electricity generator 310 according to one embodiment, includes a plurality of membrane-electrode assemblies receiving the fuel and the oxidant and inducing the fuel and the oxidant to be oxidized and reduced, respectively, thereby generating electricity energy; and a plurality of separators supplying the fuel and the oxidant to the electrodes of the membrane-electrode assembly, respectively. Here, the electricity generator 310 has a stack structure in which the plurality of membrane-electrode assemblies and separators are continuously arranged.

In one embodiment, each membrane-electrode assembly includes an electrolyte membrane 311, and an anode electrode 313 and a cathode electrode 315 attached to opposite sides of the electrolyte membrane 311. The separator includes first and second plates 317 and 319 adhered to opposite sides of the membrane-electrode assembly. Here, the electrolyte membrane 311 and the cathode electrode 315 are similar to those of the above embodiments of the invention.

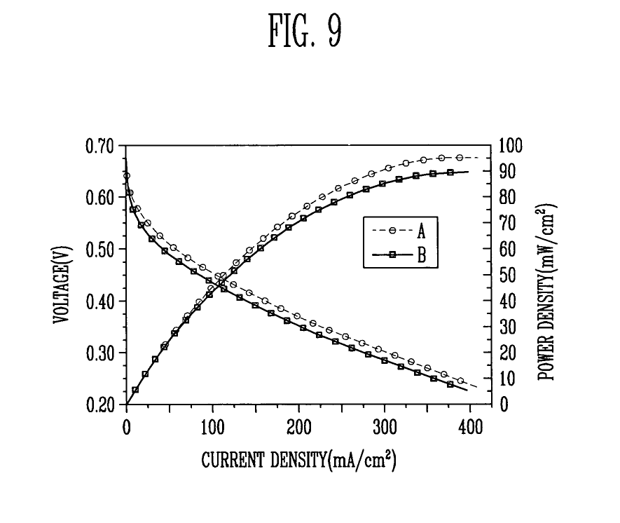

FIG. 8 is a partially enlarged sectional view of an electricity generating part of the direct methanol fuel cell system according to an embodiment of the invention.

Referring to FIG. 8, the electricity generator includes the membrane-electrode assembly and the separator. According to an embodiment, the membrane-electrode assembly includes the electrolyte membrane 311; the anode electrode 313 attached to one side of the electrolyte membrane 311 and having a catalyst layer 313a and a diffusing layer 313b; and the cathode electrode 315 having a catalyst layer 315a with an opening 312, and a diffusing layer 315b. Further, the separator includes a first plate 317 closely adhered to the anode electrode 313 and having a channel 317a and a rib 317b; and a second plate 319 closely adhered to the cathode electrode 315 and having a channel 319a and a rib 319b. In an embodiment, the first plate 317 and the second plate 319 can be adhered to each other on the rear surfaces thereof, thereby forming a bipolar plate.

In an embodiment, the channel 317a of the first plate 317 passes the liquid fuel and hydrogen gas therethrough, and the channel 319a of the second plate 319 passes the oxidant, e.g., air or oxygen, therethrough. Further, each rib 317b and 319b forms a barrier wall between the respective channels 317a, 319a, thereby forming a barrier. The fuel includes a liquid fuel containing hydrogen, e.g., methanol, ethanol, etc.

In an embodiment, the opening 312 is opposite to the channel 317a of the first plate 317. In another embodiment, the opening 312 has a width W wider than that of the channel 317a, and has a predetermined length along a forming direction of the channel 317a. In an embodiment, the area of the opening 312 is in the range of 5% to 70% of the area of the cathode catalyst layer.

With this configuration, an oxygen depleted region is formed on the opening of the cathode and an oxygen-rich region is formed on the other region of the cathode. Two regions act as two electrically connected independent cells but not ionically connected. In other words, the oxygen depletion region acts as an electrolytic cell generating hydrogen gas on the anode-side channel, whereas the oxygen-rich region still acts as a galvanic cell (the normal DMFC operation), that provides a voltage between the two electrodes. The generated hydrogen gas functions as another fuel supplied to the anode, thereby improving the output performance of a fuel cell.

The foregoing electrochemical reactions are as follows.

Reaction 1

Anode: CH₃OH+H₂O→CO₂+6H⁺+6e⁻ and H₂→2H⁺+2e⁻

Cathode: 2O₂+8H⁺+8e⁻→4H₂O

Total: CH₃OH+H₂O+H₂+2O₂→CO₂+4H₂O+current+heat.

Referring to Reaction 1, the liquid fuel and the hydrogen gas obtained therefrom are reacted with each other in the anode electrode of the direct methanol fuel cell, thereby improving the output performance of the electricity generator.

FIG. 9 is a graph showing the output performances of the fuel cell systems according to inventive and comparative examples.

As shown in FIG. 9, the membrane-electrode assembly provided with the cathode catalyst layer having the opening according to an embodiment of the invention, and the membrane-electrode assembly provided with the cathode catalyst layer having no opening are manufactured as two electricity generators having the stack structure, and compared to each other with regard to the voltage and the current density of each electricity generator.

A per the results, an average output density per fuel cell (A) of the electricity generator that employs the membrane-electrode assembly provided with the cathode catalyst layer having the opening according to an embodiment of the invention is higher than an average output density (B) of the electricity generator that employs the membrane-electrode assembly that employs the cathode catalyst layer having no opening. Thus, the invention improves the output performance of the fuel cell stack.

As described above, the invention employs a membrane-electrode assembly, which is provided with a cathode catalyst layer having an opening, in a direct methanol fuel cell, so that hydrogen gas together with liquid fuel is supplied to the anode, thereby enhancing the output performance of the stack. Further, it is possible to implement a system having high output density, so that the fuel cell system can be decreased in size. Also, the opening is formed on a cathode active region, so that the amount of expensive electrode catalyst used is reduced, thereby decreasing production costs.

Although a few embodiments of the invention have been shown and described, it would be appreciated by those skilled in the art that changes might be made in these embodiments without departing from the principles and spirit of the invention, the scope of which is defined in the claims and their equivalents.

What is claimed is:

1. A membrane-electrode assembly comprising:
a cathode provided with a catalyst layer, an opening formed in the catalyst layer, and a diffusing layer;
an anode provided with a catalyst layer and a diffusing layer; and
an electrolyte membrane placed between the cathode and the anode.

2. The membrane-electrode assembly according to claim 1, wherein the opening has an area in the range of 20% to 50% of the total area of the cathode catalyst layer.

3. The membrane-electrode assembly according to claim 1, wherein the electrolyte membrane has a rugged structure comprising at least one groove on a surface thereof facing the anode.

4. The membrane-electrode assembly according to claim 3, wherein the rugged structure has a groove depth in the range of 1 micron to 50 microns.

5. The membrane-electrode assembly according to claim 1, wherein the cathode catalyst layer has a mesh shape.

6. The membrane-electrode assembly according to claim 1, wherein the cathode catalyst layer is divided into a plurality of catalyst layers.

7. A method of manufacturing a membrane-electrode assembly, comprising:
(a) manufacturing a cathode catalyst layer unit by providing a cathode catalyst layer having an opening on a first film;
(b) manufacturing an anode catalyst layer unit by providing an anode catalyst layer on a second film;
(c) manufacturing a first diffusing layer unit by providing a diffusing layer on a second film;
(d) manufacturing an anode electrode unit by adhering the anode catalyst layer unit and the first diffusing layer unit together to contact the catalyst layers of the anode catalyst layer unit with the diffusing layers of the first diffusing layer unit;
(e) manufacturing a cathode electrode unit by adhering the cathode catalyst layer unit and a second diffusing layer unit together to contact the catalyst layers of the cathode catalyst layer unit with the diffusing layers of the second diffusing layer unit; and
(f) adhering the anode electrode unit and the cathode electrode unit to opposite sides of the electrolyte membrane.

8. A method of manufacturing a membrane-electrode assembly, comprising:
(a) providing a cathode catalyst layer having an opening on one surface of an electrolyte membrane;
(b) providing an anode catalyst layer on the other surface of the electrolyte membrane;
(c) manufacturing diffusing layer units by providing a diffusing layer on a film; and
(d) adhering the diffusing layer units to opposite sides of the electrolyte membrane such that the anode catalyst layer contacts the diffusing layer of a diffusing layer unit, and the cathode catalyst layer contacts the diffusing layer of another diffusing layer unit.

9. The method according to claim 8, wherein the opening has an area in the range of 20% to 50% of the total area of the cathode catalyst layer.

10. The method according to claim 8, further comprising:
removing the film from the diffusion layer units.

11. The method according to claim 8, further comprising:
providing a rugged structure on one surface of the electrolyte membrane.

12. The method according to claim 11, wherein the providing of the rugged structure comprises providing a first plate having the rugged structure face, contacting the first plate with the electrolyte membrane; applying heat and pressure thereto; and separating the first plate from the electrolyte membrane.

13. The method according to claim 11, wherein the opening has an area in the range of 20% to 50% of the total area of the cathode catalyst layer.

14. A method of manufacturing a membrane-electrode assembly, comprising:
(a) providing an electrolyte membrane with a first surface and a second surface, wherein the first surface has a rugged pattern;
(b) applying an anode catalyst layer to the first surface of the electrolyte membrane;
(c) manufacturing a catalyst layer unit by applying a cathode catalyst layer having an opening onto a film and drying the cathode catalyst layer;
(d) manufacturing a diffusing layer unit by providing a diffusing layer on another film and sintering the diffusing layer;
(e) manufacturing an electrode unit by adhering the catalyst layer unit and the diffusing layer unit together such that the cathode catalyst layer of the catalyst layer unit is in contact with the diffusing layer of the diffusing layer unit;
(f) removing the film from the catalyst layer unit;
(g) adhering the diffusing layer unit to the first surface of the electrolyte membrane and the electrode unit to the second surface of the electrolyte membrane; and
(h) removing the film from the diffusing layer.

15. A fuel cell system comprising:
an electricity generator including a membrane-electrode assembly, and separators provided on opposite sides of the membrane-electrode assembly;
a fuel feeder to supply fuel to the electricity generator; and
an oxidant feeder to supply an oxidant to the electricity generator,
wherein the membrane-electrode assembly includes a cathode provided with a catalyst layer, an opening formed in the catalyst layer, and a first diffusing layer; an anode provided with a catalyst layer and a second diffusing layer; and an electrolyte membrane placed between the cathode and the anode.

16. The fuel cell system according to claim 15, wherein the separator comprises:
a first plate placed on the cathode and provided with a first channel adapted to guide the oxidant to flow; and
a second plate placed on the anode and provided with a second channel adapted to guide the fuel.

17. The fuel cell system according to claim 16, wherein the second channel is opposite to the opening.

18. The fuel cell system according to claim 16, wherein the opening is wider than the width of the second channel.

19. The fuel cell system according to claim 15, wherein the opening has an area in the range of 20% to 50% of the total area of the cathode catalyst layer.

20. The fuel cell system according to claim 15, wherein the electrolyte membrane has a rugged structure comprising at least one groove on a surface thereof facing the anode.

21. The fuel cell system according to claim 20, wherein the rugged structure has a groove depth in the range of 1 micron to 50 microns.

22. The fuel cell system according to claim 15, wherein the cathode catalyst layer has a mesh shape.

23. The fuel cell system according to claim 15, wherein the cathode catalyst layer is divided into a plurality of catalyst layers.
